(19) United States
(12) Patent Application Publication
(10) Pub. No.: US 2009/0255400 A1
(43) Pub. Date: Oct. 15, 2009

(54) Hybrid Piston Rod

(75) Inventor: Elson B. Fish, Lakeville, IN (US)

Correspondence Address: BARNES & THORNBURG LLP, P.O. BOX 2786, CHICAGO, IL, 60690-2786, US

(73) Assignee: POLYGON COMPANY, Walkerton, IN (US)

(21) Appl. No.: 12/423,549

(22) Filed: Apr. 14, 2009

Related U.S. Application Data
(60) Provisional application No. 61/044,522, filed on Apr. 14, 2008.

(51) Int. Cl. F16C 7/02

(52) U.S. Cl. 92/172

(57) ABSTRACT

A hybrid piston rod having an outer metallic jacket bonded to a pultruded composite core. The composite core formed of fibrous strands coupled together by a binder material. The hybrid piston rod includes couplers that permit the hybrid piston rod to be coupled to a piston and positioned with a hydraulic cylinder. The resultant hydraulic cylinder can be used for construction equipment or in other applications where hydraulic cylinders are used.

### CROSS-REFERENCE TO RELATED PATENT APPLICATIONS

This application claims priority to U.S. Provisional Application Ser. No. 61/044,522 that was filed on Apr. 14, 2008 and is incorporated in its entirety by reference herein.

### BACKGROUND

A piston rod is used in combination with a piston and is positioned within a cylinder. The piston rod and piston move in a linear motion within the cylinder in response to a hydraulic force being applied to the piston. There is a need in the fluid power industry to reduce the weight of the piston rod in hydraulic cylinders to make the systems, in which they are used, lighter and more energy efficient. The primary criterion for determining diameter of the piston rod for a given hydraulic application is the column buckling requirements for the rod. While it is possible to manufacture a hollow piston rod, the resultant rod would sacrifice in buckling resistance. As an example, a hollow steel piston rod would reduce overall rod weight by forty percent but would reduce column buckling resistance by thirty percent as compared to a solid steel piston rod.

### SUMMARY

The present disclosure relates to piston rods for use in hydraulic applications. The piston rod is coupled to a piston and positioned within a hydraulic cylinder. The piston rods and piston move in reaction to a hydraulic pressure being applied to the piston. The force of the piston rod can be used in various hydraulic operations.

In illustrative embodiments, the hybrid piston rod includes an outer metallic jacket or sleeve bonded to a pultruded composite core. The hybrid piston rod is coupled to a piston and is positioned with a hydraulic cylinder. The resultant hydraulic cylinder can be used for construction equipment or in other applications where hydraulic cylinders are used. The weight savings achieved by using the hybrid piston rod is approximately thirty percent with only a twelve percent reduction in buckling properties. The ratio of weight reduction to column buckling is significantly greater with the hybrid piston shaft. Since the piston rod weight often represents half the weight of the complete hydraulic cylinder, a reduction in rod weight is a significant factor in reducing the overall cylinder weight.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a sectional view of a hydraulic cylinder having a cylinder wall, a pair of end caps and also showing a piston and hybrid piston rod positioned within the cylinder wall;

FIG. 2 is a perspective view of the hybrid piston rod showing a metal jacket surrounding a fiberglass pultruded rod;

FIG. 3 is a perspective view of the hybrid piston rod showing the metal jacket adhered to the pultruded core;

FIG. 4 is a graph of unsupported piston shaft length per factor of safety; and

FIG. 5 is a graph of shaft weight per unsupported shaft length.

### DETAILED DESCRIPTION

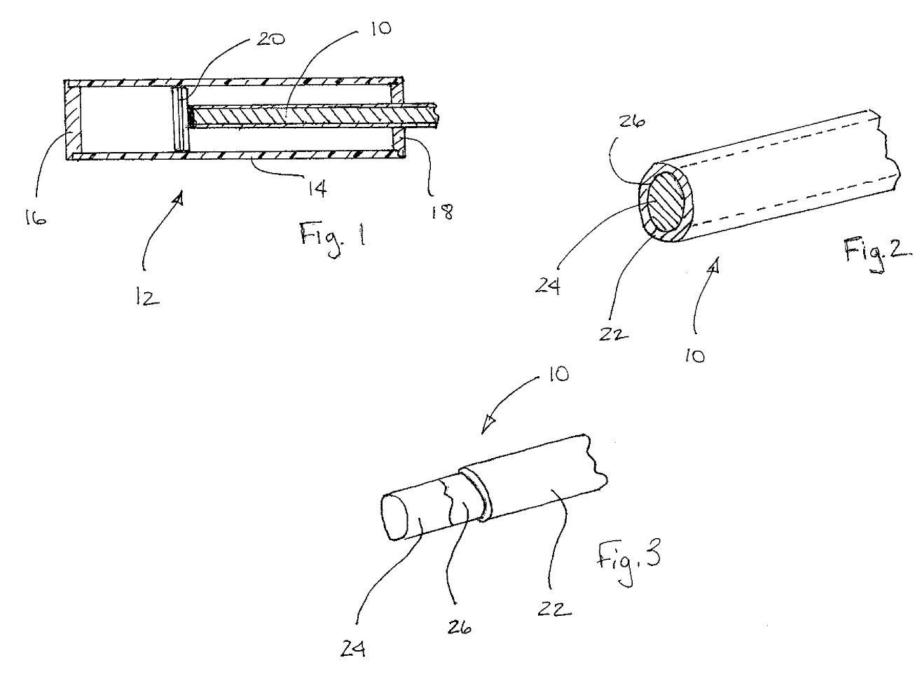

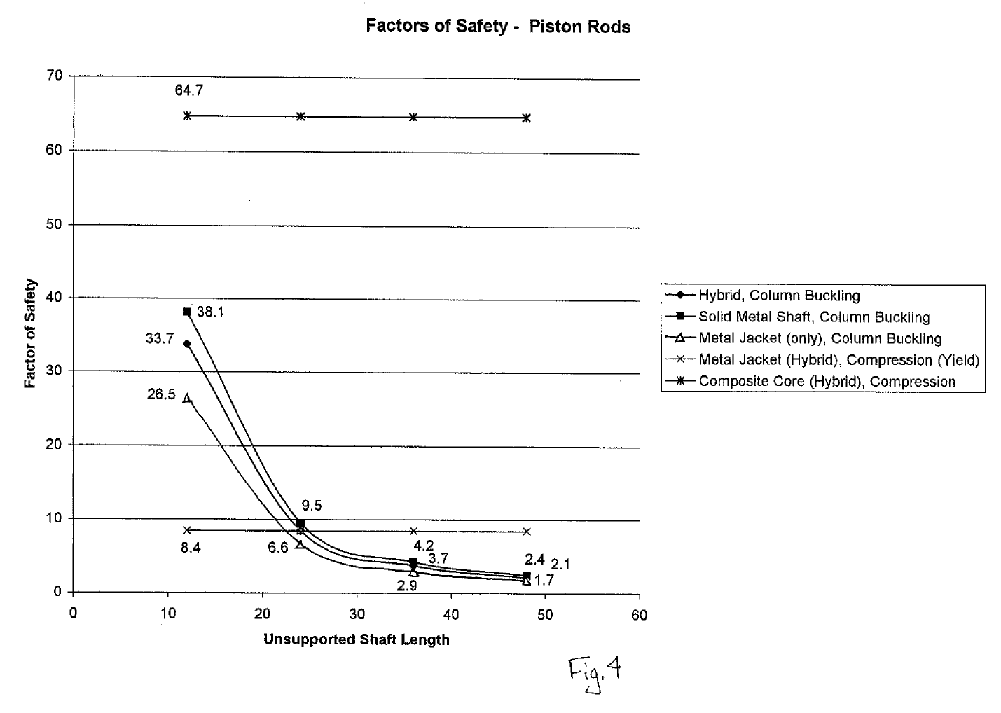

A hybrid piston rod 10 is adapted to be used in a hydraulic cylinder 12, as shown, in FIG. 1. The hydraulic cylinder 12 includes a tubular cylinder wall 14, and first and second end caps 16, 18. The hybrid piston rod 10 is coupled to a piston 20, which is adapted to move within the cylinder 12. The hybrid piston rod 10 consists of an outer metallic jacket or sleeve 22 bonded to a pultruded composite core 24 by use of an adhesive 26, as shown in FIGS. 2 and 3. As an example, chrome plated and polished DOM 1026 tubing can be used as a jacket around a fiberglass pultruded rod core. Both the DOM 1026 tubing and pultruded rod core are bonded together by use of adhesive 26. Other material may be used for the jacket 22 such as stainless steel. Other materials can also be used for the core 24 including pultruded graphite. Fiberglass with a thermoset plastic such as polyvinylesters can also be used, as an example. The adhesive can include epoxies and other adhesive known to have high bond characteristic between metal and composite materials.

The core 24 of the hybrid piston rod 10 is manufactured by using a pultrusion process in one embodiment. To manufacture the core using the pultrusion process, strands of fiberglass material, that are pre-coated with a thermoset resin, are passed through heated curing dies that shape and cure the rod core 24. The forming dies can control the dimension of the outer diameter of the core 24. Alternatively, the outer surface of the core 24 can be machined to a desired diameter. While thermoset resins are preferred, it may be possible to use thermoplastics, however the resultant structure would not be as resistant to buckling.

Alternatively, the fiberglass or carbon fiber strands can be dipped into a resin bath to coat the fibers before pulling them through the forming dies. The use of resin acts as a substitute to the thermoset plastic material being used to form the core 24. The outer diameter of the core is either the same diameter or slightly less than the inner diameter of the sleeve if an adhesive is used or slightly oversized if a resistance fit is to be used to secure the components together. While graphite and fiberglass strands are described, it is contemplated that other types of fibers could also be used to form the core. Also, it is contemplated that the core could be manufactured using a unidirectional molding process as opposed to a pultrusion process.

The weight savings by using hybrid piston rod 10 is 30% with only a 12% reduction in buckling properties. The ratio of weight reduction to column buckling is significantly greater with the hybrid piston rod 10 than a hollow metal piston rod. Since the piston rod weight often represents half the weight of the complete hydraulic cylinder 12, a reduction in rod weight is a significant factor is reducing the overall cylinder weight. Listed below are several analytical scenarios for samples of the hybrid piston rod 10.

| Reference Cylinder | | | |
|---|---|---|---|
| 1 | 2 | 3 | 4 |

Input:

| | | | | |
|---|---|---|---|---|
| Cylinder Bore Size (in) | 1.5 | 1.5 | 1.5 | 1.5 |
| Operating Pressure (psi) | 3000 | 3000 | 3000 | 3000 |
| Factor of Safety | 4 | 4 | 4 | 4 |
| Unsupported Length (in) | 12 | 24 | 36 | 48 |
| Clevis Pin Hole Diameter (in) | 0.64 | 0.64 | 0.64 | 0.64 |
| Metal Type | DOM 1026 | DOM 1026 | DOM 1026 | DOM 1026 |
| ldm | 0.625 | 0.625 | 0.625 | 0.625 |
| ldm, tolerance | −0.006 | −0.006 | −0.006 | −0.006 |
| Odm | 1.000 | 1.000 | 1.000 | 1.000 |
| Emx | 30000000 | 30000000 | 30000000 | 30000000 |
| Tm yield | 65000 | 65000 | 65000 | 65000 |
| Tm, ultimate | 75000 | 75000 | 75000 | 75000 |
| Density −m, lb/in\hat{ }3 | 0.282 | 0.282 | 0.282 | 0.282 |
| Composite Type | Pultruded | Pultruded | Pultruded | Pultruded |
| ODc | 0.615 | 0.615 | 0.615 | 0.615 |
| Ecx | 6000000 | 6000000 | 6000000 | 6000000 |
| Tcx | 100000 | 100000 | 100000 | 100000 |
| Ccx | 100000 | 100000 | 100000 | 100000 |
| Density −c, lb/in\hat{ }3 | 0.074 | 0.074 | 0.074 | 0.074 |

Results:

| | | | | |
|---|---|---|---|---|
| Compression Force (Full face) | 5301 | 5301 | 5301 | 5301 |
| Tensile Force (Rod face) | 4410 | 4410 | 4410 | 4410 |
| C/S area metal | 0.478602 | 0.478602 | 0.478602 | 0.478602 |
| C/S area composite | 0.297057 | 0.297057 | 0.297057 | 0.297057 |
| C/S area total | 0.775659 | 0.775659 | 0.775659 | 0.775659 |
| “I” metal | 0.041597 | 0.041597 | 0.041597 | 0.041597 |
| “Ix” composite | 0.007022 | 0.007022 | 0.007022 | 0.007022 |
| “I” total | 0.048619 | 0.048619 | 0.048619 | 0.048619 |
| Ex hybrid | 26533701 | 26533701 | 26533701 | 26533701 |
| Jo hybrid, polar moment of | 0.098175 | 0.098175 | 0.098175 | 0.098175 |
| inertia | | | | |
| ko, hybrid, radius of gyration | 0.355766 | 0.355766 | 0.355766 | 0.355766 |
| C, coefficent of constraint | 1 | 1 | 1 | 1 |
| Critical column buckling stress, | 230178 | 57545 | 25575 | 14386 |
| hybrid | | | | |
| Compression stress in hybrid | 6834 | 6834 | 6834 | 6834 |
| piston rod | | | | |
| Colume Buckling Factor of | 33.7 | 8.4 | 3.7 | 2.1 |
| Safety, Hybrid | | | | |
| Compression Strain, hybrid | 0.003091 | 0.006182 | 0.009272 | 0.012363 |
| Compression stress in metal | 7728 | 7728 | 7727 | 7727 |
| jacket | | | | |
| Compression stress in | 1546 | 1546 | 1545 | 1545 |
| composite core | | | | |
| Compression Yield Factor of Safety - | 8.4 | 8.4 | 8.4 | 8.4 |
| Metal Jacket | | | | |
| Compresion Factor of Safety - | 64.7 | 64.7 | 64.7 | 64.7 |
| Compoiste | | | | |
| Jo, metal jacket, polar moment | 0.068214 | 0.068214 | 0.068214 | 0.068214 |
| of inertia | | | | |
| ko, metal jacket, radius of | 0.377528 | 0.377528 | 0.377528 | 0.377528 |
| gyration | | | | |
| Critical column buckling stress, | 293060 | 73265 | 32562 | 18316 |
| metal jacket (only) | | | | |
| Compresion stress in metal | 11076 | 11076 | 11076 | 11076 |
| jacket (only) | | | | |
| Column Buckling Factor of Safety, | 26.5 | 6.6 | 2.9 | 1.7 |
| metal jacket (only) | | | | |
| Jo, Metal (solid shaft), polar | 0.098175 | 0.098175 | 0.098175 | 0.098175 |
| moment of inertia | | | | |
| ko, metal shaft, radius of | 0.355766 | 0.355766 | 0.355766 | 0.355766 |
| gyration | | | | |
| Critical column buckling stress, | 260248 | 65062 | 28916 | 16265 |
| metal shaft (solid) | | | | |
| Compresion stress in metal shaft | 6834 | 6834 | 6834 | 6834 |
| (solid) | | | | |
| Column Buckling Factor of Safety, | 38.1 | 9.5 | 4.2 | 2.4 |
| metal shaft only | | | | |
| Wt/Length Metal Jacket | 1.6196 | 3.2392 | 4.8588 | 6.4784 |
| Wt/Length Composite Core | 0.2638 | 0.5276 | 0.7914 | 1.0551 |
| Wt/Length Hybrid piston shaft | 1.8834 | 3.7668 | 5.6502 | 7.5335 |
| Wt/Length Solid Metal Shaft | 2.6578 | 5.3156 | 7.9734 | 10.6311 |

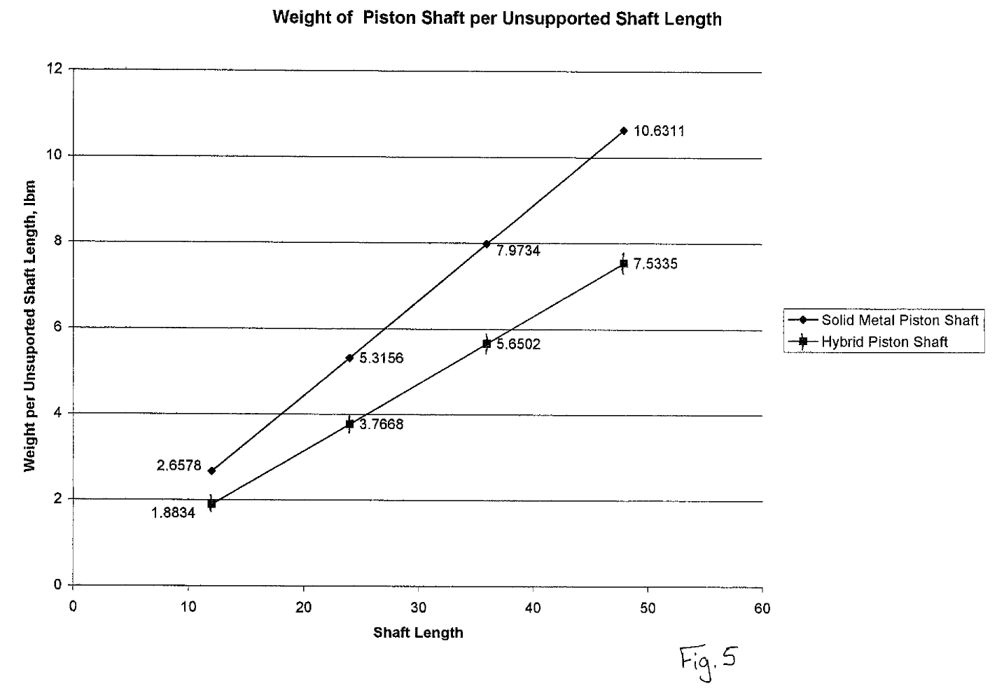

FIG. 4 is a graph of several piston rods with unsupported shaft length on the x-axis and factor of safety on the y-axis. As can be seen, the hybrid piston rod has characteristics that are very similar to the solid metal shaft with respect to column buckling. While having similar characteristics to a solid metallic rod, the weight savings are substantial.

FIG. 5 is a graph of both metal and hybrid piston rods regarding the weight of the piston rod per unsupported shaft length. The shaft length is positioned on the x-axis and the weight per unsupported shaft length is positioned on the y-axis. As can be seen the characteristics of the hybrid piston rod are very similar to the solid metal piston shaft. Data for the graph is set forth in the table.

Factors of Safety, Piston Rods

| | Shaft Unsupported Length (in) | | | |
|---|---|---|---|---|
| | 12 | 24 | 36 | 48 |
| Hybrid, Column Buckling | 33.7 | 8.4 | 3.7 | 2.1 |
| Solid Metal Shaft, Column Buckling | 38.1 | 9.5 | 4.2 | 2.4 |
| Metal Jacket (only), Column | 26.5 | 6.6 | 2.9 | 1.7 |
| Buckling | | | | |
| Metal Jacket (Hybrid), Compression | 8.4 | 8.4 | 8.4 | 8.4 |
| (Yield) | | | | |
| Composite Core (Hybrid), | 64.7 | 64.7 | 64.7 | 64.7 |
| Compression | | | | |

Shaft Weights per Unsupported
Length

| | Shaft Length (in) | | | |
|---|---|---|---|---|
| | 12 | 24 | 36 | 48 |
| Solid Metal Piston Shaft | 2.6578 | 5.3156 | 7.9734 | 10.6311 |
| Hybrid Piston Shaft | 1.8834 | 3.7668 | 5.6502 | 7.5335 |

The hybrid piston rod 10 can be used in place of traditional all steel piston rods to provide for a significant savings in weight but provide for similar strength properties. The ends of the piston rod 10 can be finished with couplings to allow the rod 10 to be coupled to the piston on one end and to other components on the second end. The couplings can be either welded to the jacket 22 of piston rod 10 or secured by threading, pinning, adhesive, or resistance fit. The couplings can be either butted up to the end of the position rod 10 or positioned within the jacket 22. If positioned within the jacket 22, the core 24 would be positioned to lie against the coupling.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A hybrid piston rod adapted to be coupled to a hydraulic piston for use in a hydraulic cylinder comprising:
a core formed of a series of fibrous strands coupled together by use of a binder material, the core having an outer diameter;
a metallic sleeve positioned around the core, the metallic sleeve having an inner diameter and an outer diameter;
wherein the inner diameter of the metallic sleeve is about the same diameter as the outer diameter of the core to permit the core to be positioned within the metallic sleeve; and
at least one connector coupled to one end of the metallic sleeve, wherein the connector is configured to be coupled to the hydraulic piston.

2. The hybrid piston rod of claim 1, wherein the core includes of substantially linear fiberglass fibers that extend substantially the length of the core.

3. The hybrid piston rod of claim 2, wherein the fiberglass fibers are coupled together using a thermoset resin.

4. The hybrid piston rod of claim 3, wherein the core is formed using a pultrusion process.

5. The hybrid piston rod of claim 1, wherein the core is formed using graphite fibers.

6. The hybrid piston rod of claim 5, wherein the graphite fibers are bonded together by a resin.

7. The hybrid piston rod of claim 1, wherein the connector is coupled to the end of the piston rod by welding.

8. The hybrid piston rod of claim 1, wherein the connector is coupled to the end of the piston rod by pinning.

9. The hybrid piston rod of claim 1 wherein the core is coupled to the metallic sleeve by use of an adhesive.

10. The hybrid piston rod of claim 1, wherein the core is coupled to the metallic sleeve by a resistance fit.

11. A hydraulic cylinder for use in hydraulic applications comprising:
a tubular cylinder having a central bore;
first and second end caps coupled to the tubular cylinder;
a piston positioned within the central bore of the tubular cylinder;
a hybrid piston rod coupled to the piston at a first end the hybrid piston rod formed to include;
a core formed of a series of fibrous strands coupled together by use of a binder material, the core having an outer diameter;
a metallic sleeve positioned around the core, the metallic sleeve having an inner diameter and an outer diameter, wherein the inner diameter of the metallic sleeve is approximately the same size as the outer diameter of the core to permit the core to be positioned within the metallic sleeve; and
at least one connector coupled to one end of the metallic sleeve, wherein the connector is configured to be coupled to the piston.

12. The hydraulic cylinder of claim 11, wherein the core includes of substantially linear fiberglass fibers that extend substantially the length of the core.

13. The hydraulic cylinder of claim 12, wherein the fiberglass fibers are coupled together using a thermoset resin.

14. The hydraulic cylinder of claim 13, wherein the core is formed using a pultrusion process.

15. The hydraulic cylinder of claim 11, wherein the core is formed using graphite fibers.

16. The hydraulic cylinder of claim 15, wherein the graphite fibers are bonded together by a resin.

17. The hydraulic cylinder of claim 11, wherein the connector is coupled to the end of the piston rod by welding.

18. The hydraulic cylinder of claim 11, wherein the connector is coupled to the end of the piston rod by pinning.

19. The hydraulic cylinder of claim 11 wherein the core is coupled to the metallic sleeve by use of an adhesive.

20. The hydraulic cylinder of claim 11, wherein the core is coupled to the metallic sleeve by a resistance fit.

21. A hybrid piston rod for use with a piston in a hydraulic cylinder comprising:
a core formed of linearly oriented fibrous strands coupled together by a thermoset resin so that the fiberglass strands extend along the length of the core, the core having an outer diameter;
a metal sleeve positioned around the core, the metal sleeve having an inner diameter and an outer diameter, wherein the inner diameter of the metal sleeve is approximately the same size as the outer diameter of the core to permit the core to be positioned within the metal sleeve; and
first and second couplings coupled to first and second ends of the metal sleeve so that the hybrid piston rod can be coupled to a piston.
